(19) United States
(12) Patent Application Publication
(10) Pub. No.: US 2008/0180764 A1
(43) Pub. Date: Jul. 31, 2008

(54) IMAGE FORMING APPARATUS

(75) Inventors: Eiji Wakiyama, Suntou-gun (JP); Yasuhiro Uchida, Yokohama-shi (JP); Minoru Kawanishi, Yokohama-shi (JP); Akira Matsushima, Suntou-gun (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/015,752

(22) Filed: Jan. 17, 2008

(30) Foreign Application Priority Data
Jan. 26, 2007 (JP) 2007-017121

(51) Int. Cl. H04N 1/04

(52) U.S. Cl. 358/498

(57) ABSTRACT

When a sheet containing portion is attached to an accommodating portion, a drawing-in member which is rotatably provided on an accommodating portion is engaged with a locking member which is turnably provided on the sheet containing portion and in this state, the drawing-in member is rotated. With this, the locking member is turned and the sheet containing portion is drawn into the accommodating portion. The guide member is provided with a guide portion and an introduction opening. When the sheet containing portion is attached, the locking member is introduced to the guide portion from the introduction opening. A forming range of the introduction opening in a direction intersecting with an attaching direction of the sheet containing portion is set equal to or smaller than a forming range of the guide portion in a direction intersecting with the attaching direction of the sheet containing portion.

### BACKGROUND OF THE INVENTION

1. Field of the Invention

The present invention relates to an image forming apparatus, and more particularly, to an image forming apparatus to which a sheet containing portion containing sheets is detachably attachable.

2. Description of the Related Art

In a conventional image forming apparatus such as a copy machine, a printer and a facsimile machine, a sheet cassette which is a sheet containing portion in which sheets are contained is detachably attached to a machine main body. In such an image forming apparatus, when an image is to be formed, sheets accommodated in the sheet cassette are sequentially transferred to an image forming portion, and an image is recorded on the sheet in the image forming portion.

The sheet cassette is attached and detached for charging sheets, or for changing sheets to other sheets having different sheet size. However, if the attaching operation of the sheet cassette is carried out after the sheets are charged, since the sheet cassette after the sheets are charged is heavy, this becomes a large burden for a user at the time of operation. When the sheet cassette is heavy, if a user attaches the sheet cassette to the machine main body with an excessive force, since the sheet cassette gains force in the attaching direction, an impact is generated when the sheet cassette is attached, and a position of the charged sheets is deviated by the impact in some cases.

Conventionally, there is an apparatus in which a machine main body accommodates a sheet cassette, the machine main body is provided with a cassette accommodating portion and a drawing-in device is provided in the cassette accommodating portion. This technique is disclosed in Japanese Patent Application Laid-open No. 2006-151687. When the sheet cassette is inserted into the cassette accommodating portion, a locking pin provided on a back surface of the sheet cassette is locked to the drawing-in device, and the sheet cassette is drawn by the drawing-in device through the locking pin.

FIG. 8 shows a structure of such a conventional drawing-in device. The drawing-in device 101 includes a toggle mechanism 101C having a rotatable toggle arm 121, a toggle shaft 124 serving as a rotating center of the toggle arm 121, and a toggle spring 125.

The toggle spring 125 is provided between a shaft 126 provided on a drawing-in device main body 101A and a connecting shaft 123 provided on the toggle arm. A contraction force of the toggle spring 125 generates a rotation moment in the toggle arm 121, and a force for drawing the sheet cassette is generated.

A rotating end of the toggle arm 121 is formed with a toggle receiving portion 122 which locks to a locking pin 171 provided on a locking arm 172 which is turnably provided on the sheet cassette. If the toggle arm 121 rotates in a state where the toggle receiving portion 122 is locked to the locking pin 171, it is possible to draw the sheet cassette through the locking pin 171.

A spring force of the toggle spring 125 is applied in the following manner.

As illustrated in FIG. 9A, a straight line connecting the toggle shaft 124 and the shaft 126 with each other is defined as a neutral line M. If the connecting shaft 123 passes through the neutral line M as the toggle arm 121 rotates, a spring force of the toggle spring 125 acts in a direction separating the connecting shaft 123 from the neutral line M, thereby rotating the toggle arm 121. That is, if the connecting shaft 123 exceeds the neutral line M, the connecting shaft 123 is biased in a direction separating from the neutral line M on the exceeding side and the connecting shaft 123 is moved. With this, the toggle arm 121 rotates and moves on a frontward side (state illustrated in FIG. 9B) and a rearward side in the attaching direction of the sheet cassette.

In a standby state before the sheet cassette is attached, the toggle arm 121 is located at a position illustrated in FIG. 9A. If the sheet cassette is inserted and with this, if the toggle arm 121 which grasps the locking pin 171 of the sheet cassette by the toggle receiving portion 122 rotates, the connecting shaft 123 exceeds the position of the neutral line M. With this, the toggle arm 121 rotates toward the downstream side in the attaching direction of the sheet cassette as illustrated in FIG. 10, and the sheet cassette is drawn toward the paper feeding position where sheets can be fed. If the sheet cassette is drawn by the toggle spring 125 in this manner, a burden on a user when the sheet cassette is inserted can be lightened, if the spring force of the toggle spring 125 is adjusted, it is possible to prevent the impact when the cassette is inserted, and the problems of the positional deviation of sheets and breakage of the sheets can be solved.

In FIG. 8, a reference symbol represents a guide groove formed in an upper surface of a main body of the drawing-in device. When the sheet cassette is drawn, the locking pin 171 moves along the guide groove 150. A reference symbol 151 represents an introduction opening for introducing the locking pin 171 on the side of the sheet cassette to the guide groove 150.

The guide groove 150 includes a straight portion 154 which is in parallel to the attaching direction of the sheet cassette and which is formed into a straight shape, and a curved portion 155 provided downstream in the attaching direction of the sheet cassette.

When the locking pin 171 moves along the guide groove 150, as the sheet cassette is drawn, a position of a point of action of moment with respect to the locking pin 171 of the toggle arm 121 which transmits a force to the locking pin 171 is varied every moment.

When a final phase region on the rearward side of the guide groove 150 is straight, the point of action of moment with respect to the locking pin 171 which was moving toward the toggle shaft 124 to that time moves in a direction separating away from the toggle shaft 124. If the point of action of moment moves in the direction separating away from the toggle shaft 124, a transferring force for drawing the sheet cassette 52 becomes weak, and there is an adverse possibility that a drawing failure occurs.

Hence, the rearward side of the guide groove 150 is formed into the curved portion 155 which is curved into an arc shape around the toggle shaft 124. By forming the curved portion 155 on the rearward side of the guide groove 150 into the curved shape instead of the straight shape, reduction in drawing force in the final phase region of the guide groove 150 is prevented.

In the conventional image forming apparatus, it is necessary that the toggle receiving portion 122 and the locking pin 171 of the sheet cassette do not interfere with each other when the sheet cassette is inserted. Therefore, the introduction opening 151 of the drawing-in device 101 is formed with a bypassing portion 152 for avoiding the interference between the locking pin 171 and the toggle receiving portion 122 of the toggle arm 121 as illustrated in FIG. 11.

By forming the bypassing portion 152 for avoiding the interference, the locking pin 171 can move to a position where the locking pin 171 is grasped by the toggle receiving portion 122 without interfering with the toggle receiving portion 122 while rotating in a direction perpendicular to the attaching direction of the sheet cassette when the sheet cassette is inserted. After this, in the curved portion 155, the locking pin 171 turns in a range of a drawing width W3 in a direction perpendicular to the attaching direction of the sheet cassette (lateral direction, hereinafter) by the curved shape of the curved portion 155.

That is, when the sheet cassette is attached, it is necessary that a total turning range W in the lateral direction of the locking pin 171 is a total of an avoiding width W1 in the bypassing portion 152 and a drawing width W3 in the curved portion 155 having the curved shape as illustrated in the equation (1).

total turning range W=avoiding width W1+drawing width W3 (1)

Therefore, in order to draw the sheet cassette by the drawing-in device 101, it is necessary that the locking pin 171 be mounted on the sheet cassette such that the locking pin 171 can turn at least in the total turning range W.

In order to reliably introduce the locking pin 171 having such a turning range into the guide groove 150 through the introduction opening 151, it is necessary that a forming range Y of the introduction opening 151 is equal to or greater than the total turning range W of the locking pin 171 as illustrated in the equation (2).

forming range Y of introduction opening≧total turning range W (2)

From the equations (1) and (2), the introduction opening forming range Y is as illustrated in the equation (3).

introduction opening forming range Y≧avoiding width W1+drawing width W3 (3)

Here, if the forming range of the curved portion 155 in the lateral direction becomes large, it can be found that the drawing width W3 is also increased, and the introduction opening forming range Y also becomes large. That is, when the guide groove 150 is provided with the curved portion 155 to hold a drawing force, the introduction opening forming range Y becomes large. Here, the forming range is defined as a distance between a left end and a right end of an opening of the introduction opening 151 along the lateral direction.

If the introduction opening forming range Y becomes large, the width of the introduction opening 151 of the drawing-in device 101 adversely becomes wider and thus, the drawing-in device 101 is adversely increased in size. That is, when the curved portion 155 is provided on the guide groove 150 so as to hold a drawing force of the drawing-in device 101, there is a problem that the drawing-in device 101 is increased in size and the image forming apparatus is also increased in size.

### SUMMARY OF THE INVENTION

The present invention has been accomplished in view of such circumstances, and it is an object of the invention to provide an image forming apparatus capable of reliably drawing a sheet containing portion into the apparatus without increasing the apparatus in size.

The present invention provides an image forming apparatus in which a sheet containing portion containing sheets is detachably attached to an accommodating portion provided on a machine main body, comprising a locking member which is turnably provided in the sheet containing portion, a drawing-in member which is rotatably provided on the accommodating portion, and which is engaged with the locking member and rotated to draw the sheet containing portion into the accommodating portion when the sheet containing portion is attached to the accommodating portion, and a guide member having a guide portion which guides movement of the locking member in a drawing direction and an introduction opening which leads the locking member to the guide portion, wherein a forming range of the introduction opening in a direction intersecting with an attaching direction of the sheet containing portion is equal to or smaller than a forming range of the guide portion in the attaching direction of the sheet containing portion.

Further features of the present invention will become apparent from the following description of exemplary embodiments with reference to the attached drawings.

### BRIEF DESCRIPTION OF THE DRAWINGS

FIG. 1 is a diagram illustrating a schematic structure of a laser beam printer (LBP) which is one example of an image forming apparatus according to a first embodiment of the present invention;

FIG. 2 is a perspective view illustrating a sheet cassette which is attached to the laser beam printer and a drawing-in device which draws the sheet cassette;

FIG. 3 is a perspective view illustrating a state where the sheet cassette is pulled out from a main body of the printer;

FIG. 4 is a perspective view of a lower portion illustrating a structure of the drawing-in device;

FIG. 5 is a diagram illustrating a forming range of an introduction opening formed in the drawing-in device, a total turning range, an avoiding width, an inclination width and a drawing width of a locking pin provided on the sheet cassette;

FIG. 6 is a perspective view illustrating a sheet cassette attached to an image forming apparatus and a drawing-in device which draws the sheet cassette according to a second embodiment of the invention;

FIG. 7 is a diagram illustrating a forming range of an introduction opening provided in the drawing-in device and a total turning range of a locking pin provided on the sheet cassette;

FIG. 8 is a perspective view of a lower portion illustrating a structure of a conventional drawing-in device;

FIGS. 9A and 9B are first diagrams for describing a drawing action of the sheet cassette of the conventional drawing-in device;

FIG. 10 is a second diagram for describing the drawing action of the sheet cassette of the conventional drawing-in device; and

FIG. 11 is a diagram illustrating a forming range of an introduction opening provided in the drawing-in device and a total turning range, an avoiding width, an inclination width and a drawing width of a locking pin provided on the sheet cassette.

### DESCRIPTION OF THE EMBODIMENTS

An exemplary embodiment for carrying out the invention will be described in detail using the drawings.

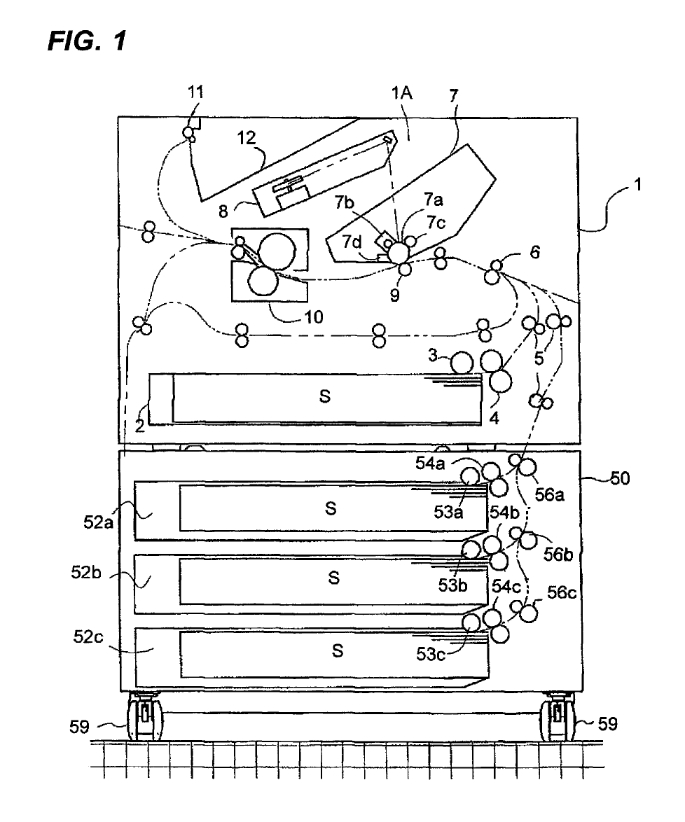

FIG. 1 is a diagram showing a schematic structure of a laser beam printer (LBP) which is one example of an image forming apparatus according to a first embodiment of the present invention.

In FIG. 1, a laser beam printer main body (printer main body, hereinafter) 1 includes an image forming portion 1A, and an option sheet feeder 50 is provided below the image forming portion 1A.

Here, the image forming portion 1A forms an image by an electrophotographic system. The image forming portion 1A includes a photosensitive drum 7a on which a toner image is formed, and a transfer roller 9 which transfers the toner image formed on the photosensitive drum 7a to a sheet S. A process cartridge 7 includes the photosensitive drum 7a, an electrification device 7b, a developing sleeve 7c and a cleaner 7d.

If an image forming operation is started in the image forming portion 1A having such a structure, the photosensitive drum 7a is illuminated by laser light corresponding to an image signal, and a latent image is formed on the photosensitive drum. Next, the latent image is developed by toner accommodated in the process cartridge 7, and a toner image (visible image) is formed on the photosensitive drum.

Parallel to the toner image forming operation, sheets S are fed from the sheet cassette 2 or the sheet cassette 52 accommodated in the option sheet feeder 50. The sheet S is transferred to a transfer portion comprising the photosensitive drum 7a and the transfer roller 9 in synchronization with an image formed on the photosensitive drum 7a by a transfer roller 5 and a pair of registration rollers 6. Then, bias is applied to the transfer roller 9 in the transfer portion and the toner image is transferred onto the sheet S.

The sheet S on which the toner image is transferred is carried to a fixing portion 10, the sheet S is pressurized and heated in the fixing portion 10 and the toner image is fixed to the sheet S and then, the sheet S is discharged to a discharge portion 12 located in an upper portion of the apparatus by a discharge roller 11.

The option sheet feeder 50 includes a plurality of (three, in this embodiment) sheet cassettes 52 (52a, 52b, 52c) and pickup rollers 53 (53a, 53b, 53c) which send out sheets S on the sheet cassette from the uppermost side.

The sheet cassettes 52 which are three sheet containing portions can stack and supply sheets of various sizes and basis weights, and the sheet cassettes 52 can detachably be attached to the option sheet feeder 50. The option sheet feeder 50 also functions as a mounting stage for the printer main body 1, and casters 59 are mounted on four locations of a lower surface of the option sheet feeder 50 so that the option sheet feeder 50 can be moved in a state where the printer main body 1 is placed on the option sheet feeder 50.

If the option sheet feeder 50 receives a feeding signal from the printer main body 1, the option sheet feeder 50 selects a sheet cassette 52 in which sheets S suitable for the feeding signal are stacked, and the sheets S can be fed by the pickup roller 53 from the selected sheet cassette 52. The sheets S fed out by the pickup roller 53 are separated by pairs of retard rollers 54 (54a, 54b, 54c) one-sheet by one-sheet and then, the sheets S are fed into the printer main body 1 by transfer rollers 56 (56a, 56b, 56c).

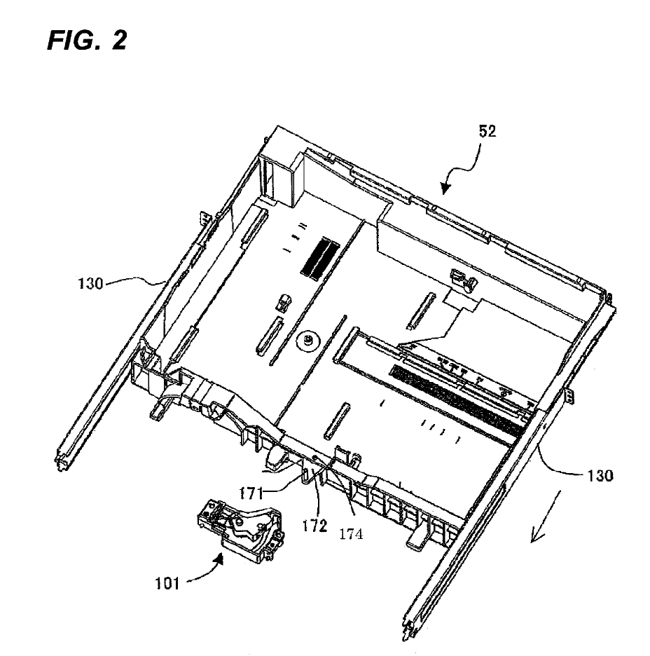

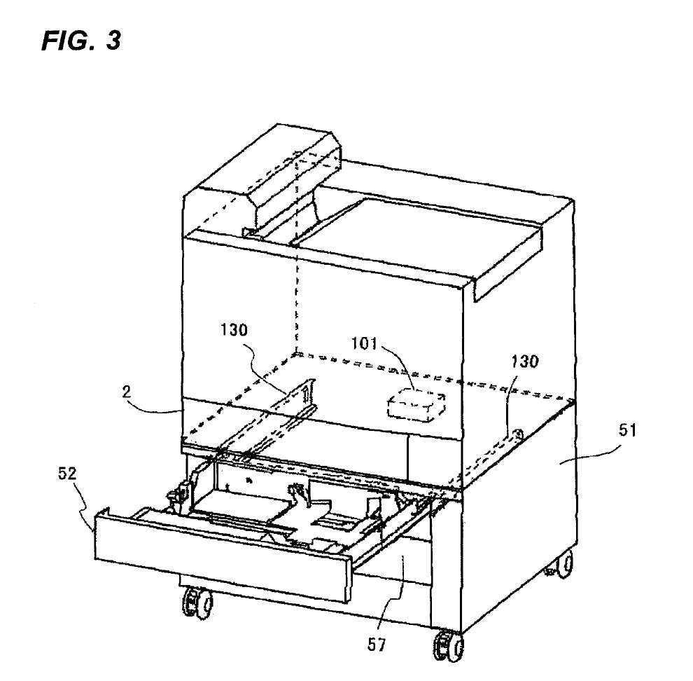

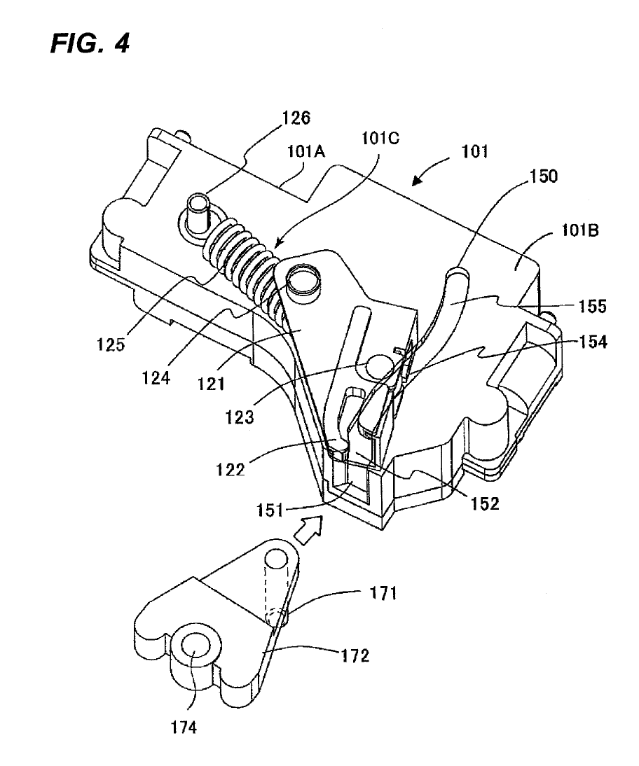

As illustrated in FIG. 2, a locking pin 171 is provided on an outer surface of the sheet cassette 52 on a frontward side in an attaching direction shown with an arrow. The locking pin 171 is grasped by a later-described drawing-in device 101 illustrated in FIG. 3. The locking pin 171 which is a locking member is suspended from a locking arm 172 which is provided on an outer surface of the sheet cassette 52 such that the locking arm 172 can turn in the lateral direction. The locking arm 172 can turn in the lateral direction with respect to the sheet cassette 52 through a shaft 174 illustrated in FIG. 4.

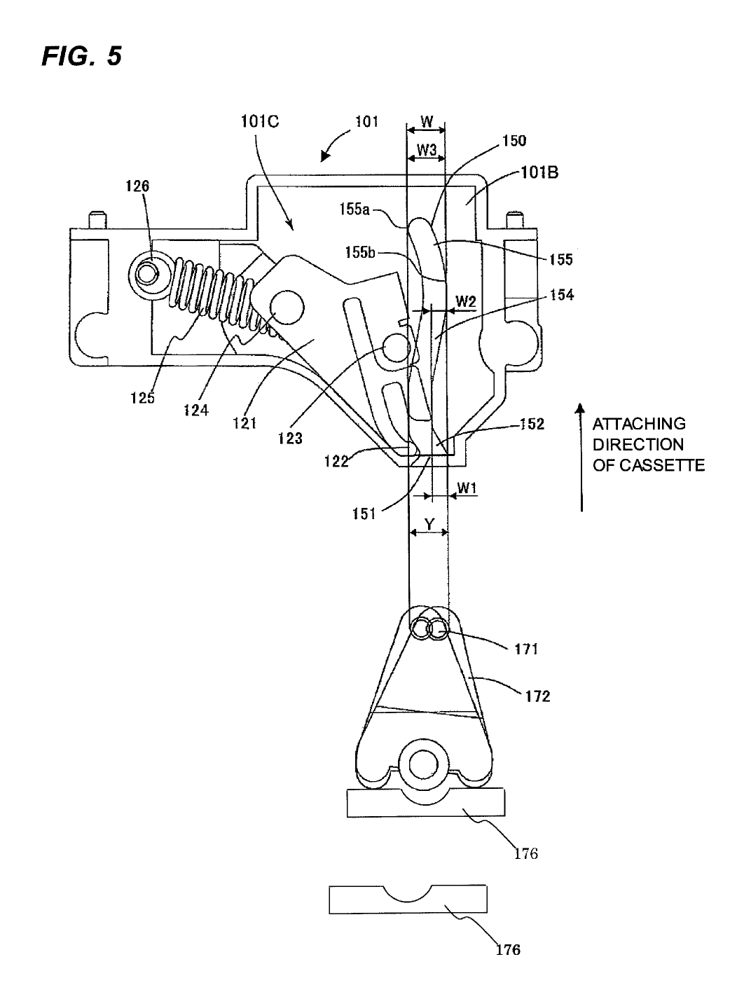

The locking arm 172 is formed with a strike portion 176 which limits a turning range of the locking arm 172 (locking pin 171) as illustrated in FIG. 5.

The strike portion 176 formed on the sheet cassette 52 can limit the turnable range of the locking pin 171 in the lateral direction together with the 172. In this embodiment, the strike portion 176 constitutes a holding portion which holes the lateral turnable range of the locking pin 171 within a range facing a later-described introduction opening.

The sheet cassette 52 is accommodated in an accommodating portion 57 provided in the option sheet feeder 50 illustrated in FIG. 3. Opposed slide guides 130 are provided on an inner wall of the accommodating portion 57. The sheet cassette 52 is guided by the slide guides 130 and pulled out from the accommodating portion 57 or the sheet cassette 52 is attached to the accommodating portion 57.

A user inserts the sheet cassette 52 into the accommodating portion 57. If the sheet cassette 52 is inserted into the accommodating portion 57, the locking pin 171 provided on the sheet cassette 52 reaches a position of the drawing-in device 101 mounted on a back plate of the accommodating portion 57, and the locking pin 171 is locked by the drawing-in device 101. Thereafter, the locking pin 171 is pulled in by the drawing-in device 101, and the sheet cassette 52 is drawn to the paper feeding position where sheets in the printer main body 1 can be fed.

As illustrated in FIG. 4, the drawing-in device 101 includes the toggle arm 121 which is rotatably provided on the drawing-in device main body 101A. When the sheet cassette 52 is attached, the toggle arm 121 which is the drawing-in member is engaged with the locking pin 171 and rotated. With this, the sheet cassette 52 is drawn into the accommodating portion while turning the locking pin 171.

The drawing-in device 101 includes the guide groove (guide portion) 150 having the intermediate portion 154 and the curved portion 155 provided on the intermediate portion 154 at a location downstream in the sheet cassette attaching direction. The introduction opening 151 is formed in an end of the guide groove 150 upstream in the sheet cassette attaching direction. The introduction opening 151 is provided for leading the locking pin 171 to the intermediate portion 154.

The introduction opening 151 is formed with the bypassing portion 152 for avoiding the interference between the toggle receiving portion 122 and the locking pin 171 of the sheet cassette 52 when the sheet cassette 52 is inserted. The straight intermediate portion 154 is formed downstream in the sheet cassette attaching direction of the interference avoiding bypassing portion 152. FIG. 4 shows a lower plate 101B of the drawing-in device main body 101A. The lower plate 101B is a guide member having the introduction opening 151 formed with the guide groove 150 and the bypassing portion 152.

In this embodiment, the intermediate portion 154 is a straight portion which is inclined in a direction away from the toggle arm 121 as moving downstream in the sheet cassette attaching direction. As illustrated in FIG. 5, an inclining amount W2 of the intermediate portion 154 has such a value that when the locking pin 171 passes, a turning range of the locking pin 171 in the lateral direction is the same as a turning range W1 when the locking pin 171 passes through the bypassing portion 152.

The curved portion 155 is curved into an arc shape which is curving around the toggle shaft 124 as a rotation center as extending downstream in the sheet cassette attaching direction of the intermediate portion 154. The intermediate portion 154 may employ such a shape that a curved portion of the intermediate portion 154 is of arc in which the curved shape of the curved portion 155 extends, and a portion of the intermediate portion 154 on the side of the introduction opening 151 is straight which is in parallel to the sheet cassette attaching direction.

In the drawing-in device 101, if the sheet cassette 52 is inserted and the locking pin 171 reaches the introduction opening 151, the locking pin 171 turns in the range of the avoiding width W1 in the lateral direction in the interference avoiding bypassing portion 152 provided in the introduction opening 151.

Then, if the sheet cassette 52 is further inserted, the locking pin 171 is connected to the toggle mechanism 101C, the locking pin 171 is grasped by the toggle receiving portion 122 of the toggle arm 121 and in this state, the locking pin 171 moves the intermediate portion 154 integrally with the toggle arm 121. At that time, the locking pin 171 turns in the range of the inclining width W2 (=avoiding width W1) in the lateral direction and moves.

Thereafter, the locking pin 171 is turned in the range of the drawing width W3 in the lateral direction in the curved portion 155 by the toggle mechanism 101C and drawn into the curved portion. With this, the sheet cassette 52 is drawn to a predetermined paper feeding position.

In FIG. 5, a symbol W represents a total turning range of the locking pin 171 until the sheet cassette 52 is drawn to the paper feeding position. The total turning range W is a total of the avoiding width W1, the inclining width W2 and the drawing width W3 in the lateral direction as described in the equation (4).

total turning range W=avoiding width W1+inclining width W2+drawing width W3 (4)

As described above, the avoiding width W1 and the inclining width W2 are equal to each other, and since the turning directions thereof are opposite from each other, a sum of the avoiding width W1 and the inclining width W2 is 0. Therefore, the total turning range W is as described in the equation (5).

total turning range W=drawing width W3 (5)

In FIG. 5, a symbol Y represents a forming range of the introduction opening 151 in the lateral direction. In order to introduce the locking pin 171 into the intermediate portion 154 through the introduction opening 151, it is necessary that the introduction opening forming range Y is equal to the total turning range W. Here, the forming range Y of the introduction opening 151 is a distance between the left end and the right end of the introduction opening 151 in a direction perpendicular to the sheet containing portion attaching direction.

Therefore, from the equations (4) and (5) the introduction opening forming range Y is as described in the equation (6).

introduction opening forming range Y=drawing width W3 (6)

In the embodiment, by inclining the intermediate portion 154 in a direction separating away from the toggle arm 121, the guide groove 150 is curved in the forming range of the introduction opening 151 in the sheet cassette attaching direction (drawing direction).

That is, the forming range of the introduction opening 151 in the lateral direction is set equal to a forming range of the guide groove 150 in the lateral direction, i.e., equal to the drawing width W3. There, the forming range of the guide groove 150 in the lateral direction is a distance between the maximum left end 155a and the maximum right end 155b of the guide groove 150 in the lateral direction along the lateral direction.

In this embodiment, the strike portion 176 constitutes the holding portion. The holding portion holes the lateral turnable range of the locking pin 171 within a range facing the introduction opening 151 when the sheet cassette 52 is attached.

With this structure, it is possible to reliably draw the sheet cassette 52 without increasing, in size, the drawing-in device 101 and the laser beam printer (image forming apparatus) having the drawing-in device 101.

Next, a second embodiment of the invention will be explained.

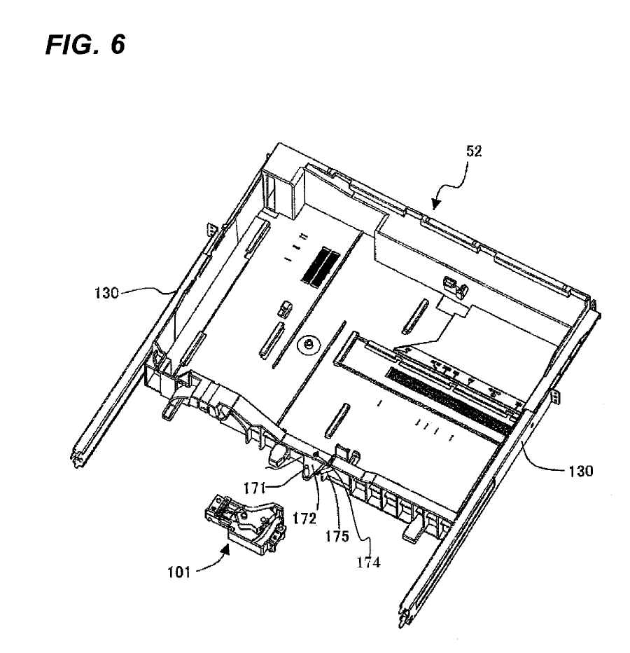

FIG. 6 is a perspective view showing a structure of the sheet cassette 52 which is drawn by the drawing-in device 101 according to the embodiment. In FIG. 6, the same symbols as those in FIG. 2 represent the same elements.

In FIG. 6, a locking spring 175 biases the locking pin 171 in a direction separating away from the toggle arm 121 in a state where the sheet cassette 52 is drawn by the drawing-in device 101. Before the sheet cassette is attached, the locking arm 172 is held in a state where the locking arm 172 is in abutment against the strike portion 176 in a direction separating away from the toggle arm 121 by the locking spring 175.

The position where the locking arm 172 is held is a position where the locking pin 171 faces the bypassing portion 152. That is, in this embodiment, the turnable locking pin 171 is held at a position where the locking pin 171 resiliently faces the bypassing portion 152 by the strike portion 176 and the locking spring 175.

In the embodiment, the groove 52b is different from that of the first embodiment, and it is only necessary that the groove 52b have such a shape that the locking pin 171 is held at a position where the locking spring 175 faces the bypassing portion 152.

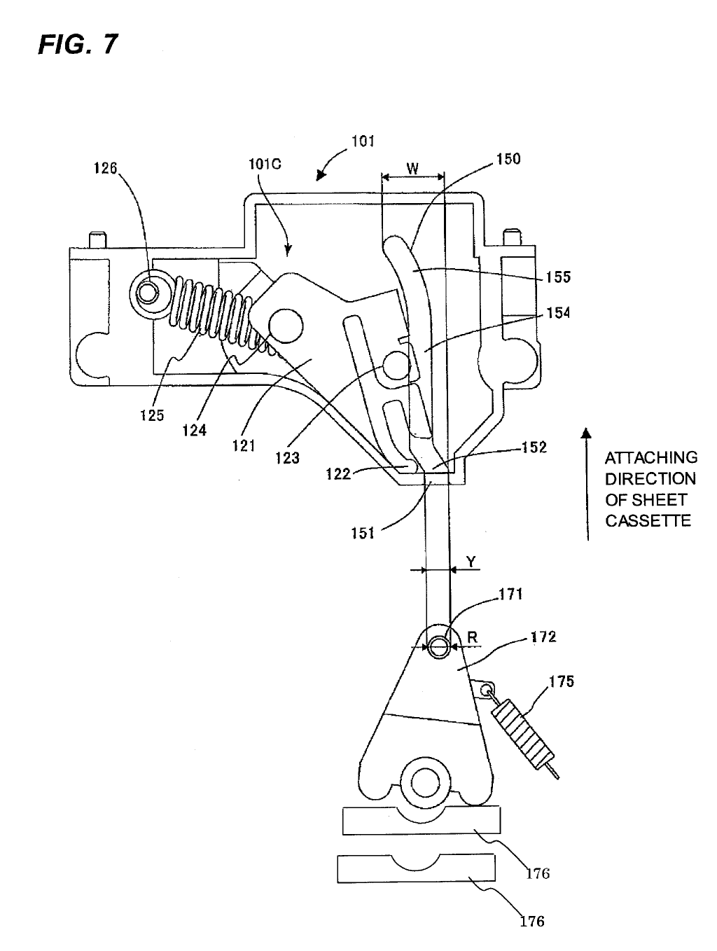

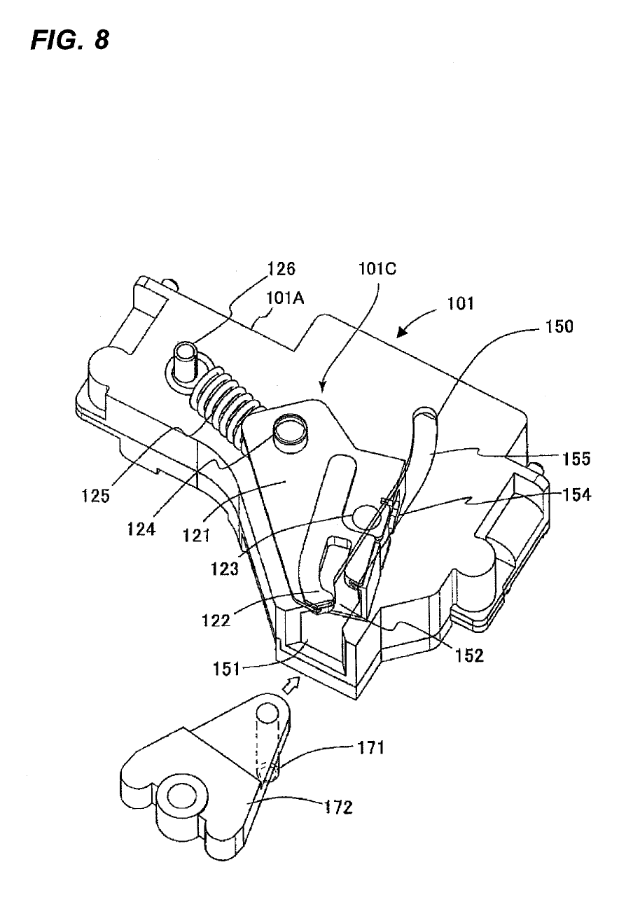

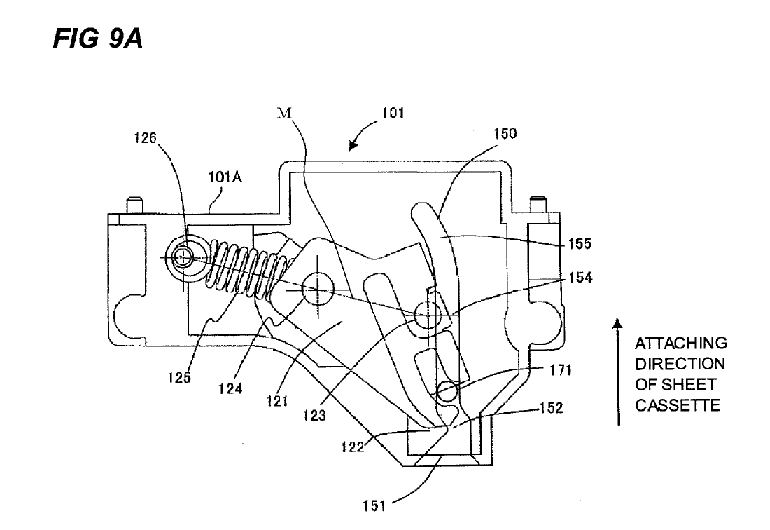

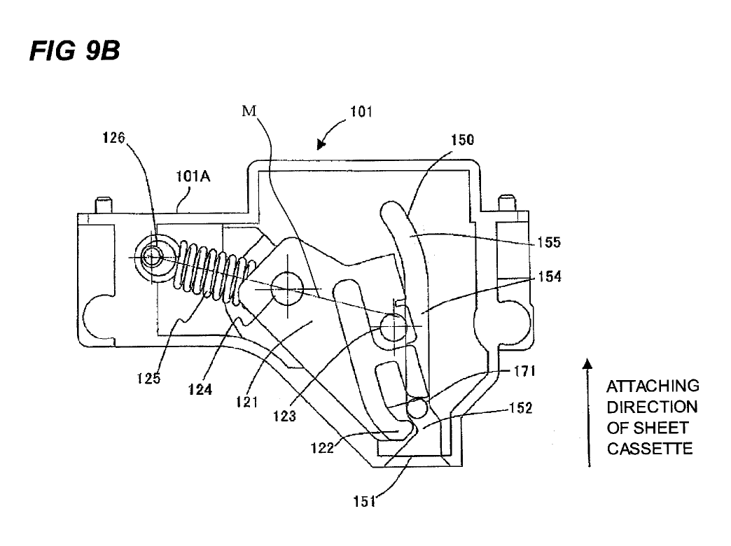

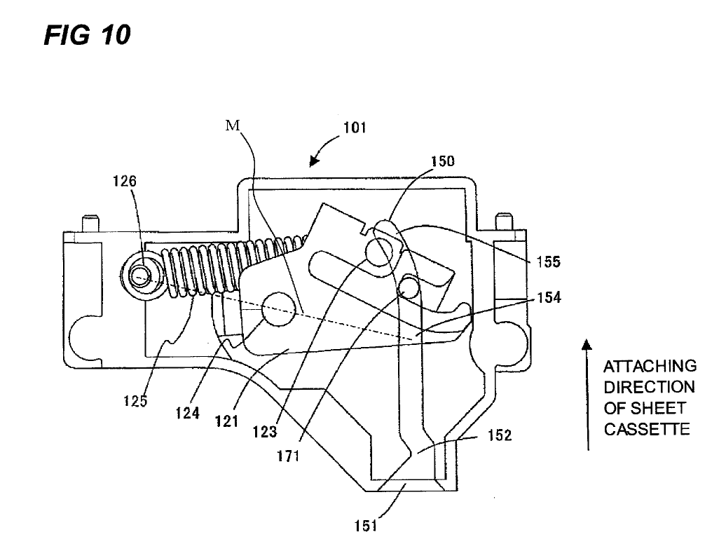

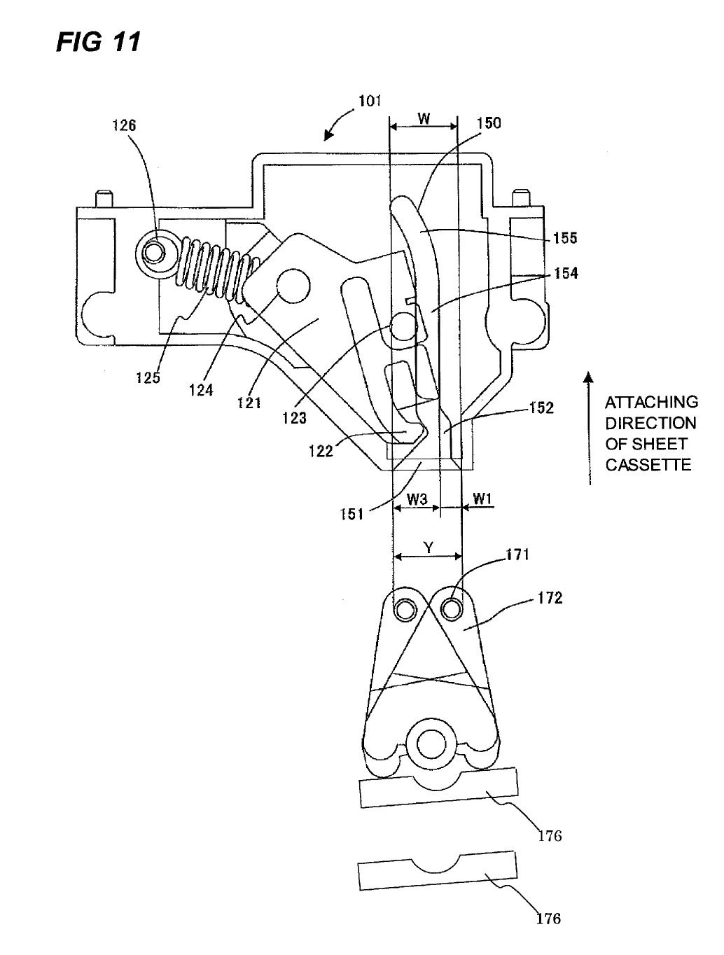

As illustrated in FIG. 7, the guide groove 150 includes the intermediate portion 154 parallel to the sheet cassette attaching direction and the curved portion 155 formed into an arc shape like the conventional technique.

The introduction opening 151 is formed at a position where the introduction opening forming range Y of the introduction opening 151 is moved in a direction separating away from the toggle arm 121 by the avoiding width W1 (see FIG. 5) of the interference avoiding bypassing portion 152 in the lateral direction.

However, since the locking pin 171 is held by the locking spring 175 at a position where the locking pin 171 faces the bypassing portion 152, the locking pin 171 is lead to the intermediate portion 154 from the bypassing portion 152 when the sheet cassette 52 is attached.

With this structure, the forming range Y of the introduction opening 151 including the interference avoiding bypassing portion 152 can be substantially equal to a diameter R of the locking pin 171 irrespective of the total turning range W of the locking pin 171. Since the diameter R of the locking pin 171 is smaller than the total turning range W, if the locking pin 171 is biased by the locking spring 175, the introduction opening forming range Y can be made smaller than the total turning range W.

In this embodiment, when the sheet cassette 52 is attached, the locking pin 171 is held in the range where the locking pin 171 faces the bypassing portion 152. With this, the forming range of the introduction opening 151 including the bypassing portion 152 can be made smaller than the forming range of the guide groove 150. With this, it is possible to reliably draw the sheet cassette 52 without increasing, in size, the drawing-in device 101 and the laser beam printer (image forming apparatus) having the drawing-in device 101.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-017121, filed Jan. 26, 2007, which is hereby incorporated by reference herein in its entirety.

What is claimed is:

1. An image forming apparatus in which a sheet containing portion containing a sheet is detachably attached to an accommodating portion provided on a machine main body, comprising;
a locking member which is turnably provided in the sheet containing portion,
a drawing-in member which is rotatably provided on the accommodating portion, and which is engaged with the locking member and rotated to draw the sheet containing portion into the accommodating portion when the sheet containing portion is attached to the accommodating portion, and
a guide member having a guide portion which guides movement of the locking member in a drawing direction and an introduction opening which leads the locking member to the guide portion, wherein
a forming range of the introduction opening in a direction intersecting with an attaching direction of the sheet containing portion is equal to or smaller than a forming range of the guide portion in the direction intersecting with attaching direction of the sheet containing portion.

2. An image forming apparatus in which a sheet containing portion containing a sheet is detachably attached to an accommodating portion provided on a machine main body, comprising;
a locking member which is pivotably provided in the sheet containing portion,
a drawing-in member which is rotatably provided on the accommodating portion, and which is engaged with the locking member and rotated to draw the sheet containing portion into the accommodating portion when the sheet containing portion is attached to the accommodating portion, and
a guide member having a guide portion which guides movement of the locking member in a drawing direction and an introduction opening which leads the locking member to the guide portion, wherein
the guide portion includes an intermediate portion and a curved portion, the intermediate portion is formed into such a shape that the intermediate portion is further from a rotation center of the drawing-in member as the intermediate portion is closer to the curved portion, and the curved portion is formed into an arc shape extending around the rotation center of the drawing-in member.

3. The image forming apparatus according to claim 1, further comprising a holding portion provided on the sheet containing portion, wherein the holding portion resiliently holds the locking member at a position where the locking member faces the introduction opening when the sheet containing portion is attached.

4. The image forming apparatus according to claim 3, wherein
the introduction opening is formed with a bypassing portion for avoiding interference between the locking member and the drawing-in member when the locking member is lead to the guide portion, and the holding portion resiliently holds the locking member at a position where the locking member faces the bypassing portion.

5. The image forming apparatus according to claim 1 or 2, wherein
the drawing-in member is connected to a toggle mechanism, and after the drawing-in member locks the locking member which is lead to the guide portion by the introduction opening, the drawing-in member is rotated by the toggle mechanism to draw the sheet containing portion.
